(19) United States
(12) Patent Application Publication
(10) Pub. No.: US 2022/0391800 A1
(43) Pub. Date: Dec. 8, 2022

(54) MAINTENANCE METHODS AND SYSTEMS FOR FLUID CONTAINMENT ASSETS

(71) Applicant: Team Industrial Services, Inc., Sugar Land, TX (US)

(72) Inventors: Jim ROWE, Sugar Land, TX (US); Neal RATNER, Sugar Land, TX (US); Peter SHWETS, Sugar Land, TX (US); Robert YOUNG, Sugar Land, TX (US)

(21) Appl. No.: 17/774,617

(22) PCT Filed: Nov. 5, 2020
(86) PCT No.: PCT/US2020/059022

§ 371 Date: May 5, 2022

Related U.S. Application Data
(60) Provisional application No. 62/931,045, filed on Nov. 5, 2019.

(51) Int. Cl. G06Q 10/06; G06N 5/02; G06Q 10/00

(52) U.S. Cl. CPC G06Q 10/06311; G06N 5/022; G06Q 10/20

(57) ABSTRACT

A method for maintaining a fluid containment asset is described. The method comprises: configuring a first schedule having a first work task on the fluid containment asset for a first project; performing the first work task on the fluid containment asset based on the first schedule; measuring a work task performance for the first work task performed based on the first schedule; collecting first work task data corresponding to the first work task performed; building a first predictive model based on at least the first work task data; configuring a second schedule using the first predictive model, wherein the second schedule has a second work task for a second project; and performing the second work task on the fluid containment asset based on the second schedule.

### CROSS-REFERENCE TO RELATED APPLICATIONS

This application claims the benefit of U.S. Provisional Patent Application No. 62/931,045, filed Nov. 5, 2019, which is incorporated by reference herein in its entirety.

### FIELD OF DISCLOSURE

In general, the disclosure describes maintenance methods and systems for mechanical fluid containment assets. More specifically, the disclosure describes maintenance methods and systems for determining the corrosion rates for the fluid containment assets and scheduling inspections and repairs of fluid containment assets.

### BACKGROUND OF DISCLOSURE

Mechanical fluid containment assets in oil, gas, and chemical industries need to be inspected periodically to determine the condition of the fluid containments assets, including corrosion rate. These assets may include atmospheric tanks, pressure vessels, fired heaters, pipes, and valves. The assets each may corrode at different rates, and corrosion may reduce the operational life of the assets. The corrosion rate of the assets is determined and tracked by scheduling multiple inspections over the life of the assets. Inspections are used to provide a data set of information to determine the condition of each asset, including corrosion rates and physical measurements of the asset.

Asset conditions may be used to determine the frequency of inspections and recommended work tasks to maintain the assets. Asset conditions of the assets continuously change over time, due to corrosion and other factors, so the type and frequency of maintenance repairs and inspections needed also change during the life of the liquid containment assets. Maintenance scheduling in an effective manner may become a challenge due to the need to dynamically determine the frequency and type of maintenance needed for each asset. Effective maintenance scheduling, including scheduling the type and frequency of inspections and repairs, helps mitigate the risk of corrosion breach of an asset and helps reduce unnecessary inspections and repairs of the asset.

What is needed is an improved method for determining the conditions of assets and for maintenance scheduling to inspect and/or repair assets that are subject to damage by corrosion.

### SUMMARY

This summary is provided to introduce a selection of concepts that are further described below in the detailed description. However, many modifications are possible without materially departing from the teachings of this disclosure. Accordingly, such modifications are intended to be included within the scope of this disclosure as defined in the claims. This summary is not intended to identify key or essential features of the claimed subject matter, nor is it intended to be used as an aid in limiting the scope of the claimed subject matter.

In one aspect, a method for maintaining a fluid containment asset is described herein. The method comprises: (a) configuring a first schedule having a first work task on the fluid containment asset for a first project; (b) performing the first work task on the fluid containment asset based on the first schedule; (c) measuring a work task performance for the first work task performed based on the first schedule; (d) collecting first work task data corresponding to the first work task performed; (e) building a first predictive model based on the first work task data; (0 configuring a second schedule using the first predictive model, wherein the second schedule has a second work task for a second project; and (g) performing the second work task on the fluid containment asset based on the second schedule.

In another aspect, a method for maintaining a fluid containment asset is described. The method comprises: performing a destructive testing (DT) on the fluid containment asset to perform a DT test on a portion of the fluid containment asset; performing a non-destructive testing (NDT) on the fluid containment asset to collect NDT data; measuring operational parameters for the fluid containment asset to collect operational parameter data; compiling an asset data set from the DT data, the NDT data and the operational parameter data; processing the asset data set to determine condition of the fluid containment asset; and performing at least one of the following: determining a corrosion rate on the fluid containment asset, determining a useful life of the fluid containment asset, recommending an inspection frequency, recommending an inspection type; recommending a repair service; recommending a code action; or building a predictive model.

In one embodiment, the method further comprises: collecting second work task data corresponding to the second work task performed; and building a second predictive model based on the first work task data and the second work task data.

In an embodiment, the fluid-containment asset is a pipe. However, other fluid containment asset is also applicable, such as atmospheric tanks, pressure vessels, fired heaters and valves.

In one embodiment, the first work task is inspection, maintenance or repair of the fluid containment asset. In another embodiment, the first work task is thickness monitoring. Thickness monitoring can be accomplished by various methods, as further described in detail below.

In one embodiment, the destructive testing is performed by hot tapping to obtain a portion of the pipe, but other destructive testing is also applicable, such as corrosion testing, fracture and mechanical testing, fatigue testing, or other testings known to a person skilled in the art.

Corrosion testing can involve subjecting the sample to different corrosion agent, such as the fluid to be transported through the pipe, and measure the corrosion rate in a controlled environment.

Fracture and mechanical testing includes different types of destructive testing methods such as tension tests, bend tests, Charpy impact tests, Pellini drop weight testing, peel tests, crush testing, pressure and fracture testing. As well as the testing of metals, fracture and mechanical tests can be carried out on different materials, such as welded polymers including plastic pipes.

Fatigue testing involves exposing the sample in a working environment, such as in air or seawater environments. These tests are used to test parent materials and the endurance of welded joints under constant or variable amplitude loading. This destructive testing method can also be used for fatigue crack growth testing of welds, base metals, and heat affected zones.

As used herein, a “fluid containment asset” refers to an equipment as used in the fluid transport, storage and reaction system.

As used herein, the term “schedule” refers to a predetermined time to perform a task work, such as inspection, maintenance or repair.

As used herein, “work task” refers to a scheduled task to be performed on the fluid containment asset.

As used herein, “destructive testing” refers to testing and analysis techniques used to evaluate the properties of the fluid containment asset, or portions thereof, that causes physical damage or alteration to the asset.

As used herein, “non-destructive testing” refers to testing and analysis techniques used to evaluate the properties of the fluid containment asset, or portions thereof, without causing damage to the asset.

As used herein, “corrosion rate” refers to the weight loss of a corrosion coupon after exposure to a corrosive environment, expressed as mils (thousandths of an inch) per year penetration. Corrosion rate is calculated assuming uniform corrosion over the entire surface of the coupon. mpy=(weight loss in grams)*(22,300)/(A*dt), wherein

mpy=corrosion rate (mils per year penetration)

A=area of coupon (sq. in.)

d=metal density of coupon (g/cm3)

t=time of exposure in corrosive environment (days).

As used herein, a “coupon” refers to a specimen of test material to be used in a test, usually a metal strip or ring shaped to fit into a testing cell or between joints of drillpipe. Coupons are weighed before and after testing, and weight loss is measured. For example, a portion of the pipe to undergo corrosion test is referred to as a “corrosion coupon,” although they are also examined for pits and cracks.

The use of the word “a” or “an” when used in conjunction with the term “comprising” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim.

The phrase “consisting of” is closed, and excludes all additional elements.

The phrase “consisting essentially of” excludes additional material elements, but allows the inclusions of non-material elements that do not substantially change the nature of the invention.

### BRIEF DESCRIPTION OF THE FIGURES

Certain embodiments of the disclosure will hereafter be described with reference to the accompanying drawings, wherein like reference numerals denote like elements. It is emphasized that, in accordance with standard practice in the industry, various features are not drawn to scale. In fact, the dimensions of various features may be arbitrarily increased or reduced for clarity of discussion. It should be understood, however, that the accompanying figures illustrate the various implementations described herein and are not meant to limit the scope of various technologies described herein, and:

FIG. 1 is a schematic diagram representation of a maintenance method for fluid containment assets in accordance with embodiments of the present disclosure;

FIG. 2 is a schematic diagram representation of a method for determining conditions of fluid containment assets in accordance with embodiments of the present disclosure;

FIG. 3 is a view of a hot tap being performed on a pipe; and

FIG. 4 is a view of an example fluid system having multiple fluid containment assets.

### DETAILED DESCRIPTION

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”; “upper” and “lower”; “top” and “bottom”; and other like terms indicating relative positions to a given point or element are utilized to more clearly describe some elements.

Maintenance methods and systems for fluid containment assets are described in the present disclosure. The assets may include atmospheric tanks, pressure vessels, fired heaters, pipes, and valves. The assets being maintained may be components of a plant or system in the oil, gas, or chemical industries. The assets are constructed of metal and include a containment wall that is subject to corrosion so that maintenance is needed to determine the condition of the asset, including corrosion rate. The maintenance methods and systems are used for maintaining assets that may require repeated inspections and/or repairs at different times during the life of the assets.

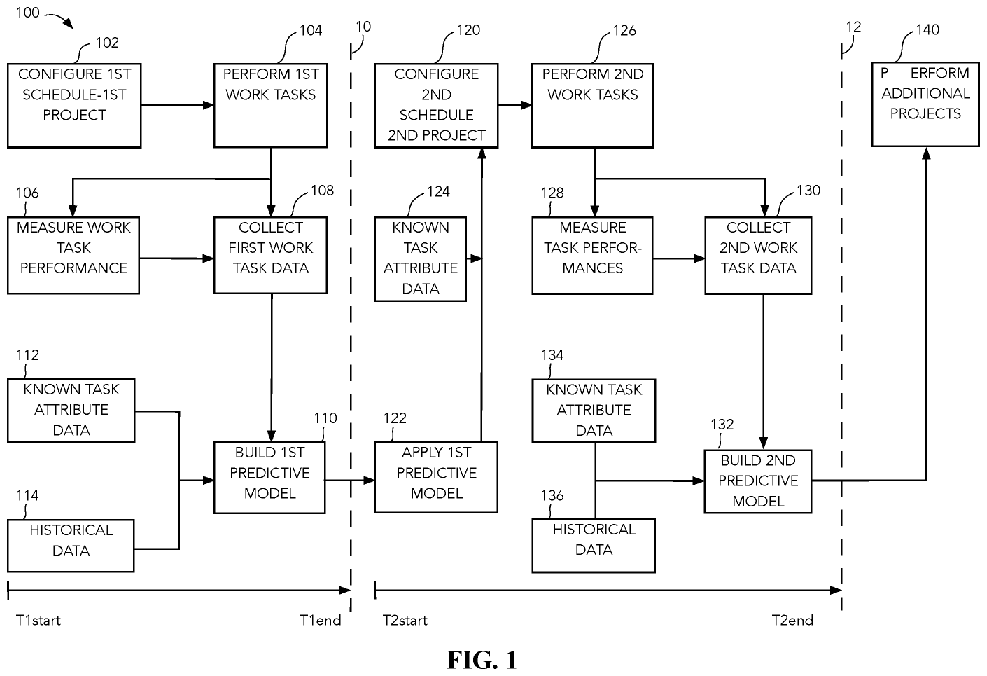

A maintenance method for generating schedules to perform work tasks associated with maintaining assets is shown in schematic form in FIG. 1, and generally designated as 100. Maintenance method 100 provides a method for generating a series of updated schedules for scheduling work tasks to perform maintenance during the life of the assets. Each successive schedule is built using a refined predictive model. The predictive models use work task data associated with the previous work tasks performed and other data to improve each successive predictive model and schedule.

In the maintenance method 100, a first schedule is configured in a first project (block 102) to schedule work tasks and to assign a workforce to perform scheduled work tasks on the assets to be maintained. The first project of the maintenance method 100 is schematically illustrated in blocks 102-114 of FIG. 1. Configuring the first schedule includes identifying work tasks for performance on at least one asset. The identified work tasks of the first schedule may include inspections and/or repairs.

Work tasks may include inspections of an asset to determine corrosion rates, repairs, and replacements of the asset. For example, a work task may include an inspection to be performed at a thickness measurement location (“TML”) on a containment wall of the asset. This type of inspection may be used to determine the thickness of the containment wall at the TML of the asset. The inspection may include measurements at multiple TMLs to generate work task data corresponding to measurements at each of the TMLs. The work tasks for determining corrosion rates and corrosion damage to containment walls may include electro-magnetic acoustic transducer (EMAT) screenings, ultrasound inspections, and manual inspections.

TMLs are specified areas on piping and pressure vessels where thickness measurement examinations are performed to observe the presence and rate of damage and corrosion. TMLs are selected by focusing on areas where degradation is likely to occur, and it may depend on the inspection history, fluid dynamics, statistical analysis and experiences.

A schedule may include task performance dates for completion of each of the work tasks. The task performance dates may include dates required by industry or governmental standards and codes. The assets being maintained using the schedule may be components of a plant or system, such as a chemical plant, with requirements to perform certain types of work tasks at a scheduled frequency. The scheduled frequency may vary based on the condition of the assets. Configuring the schedule (block 102) further may include assigning a workforce to perform the individual work tasks. The schedule may include assigning a technician or a group of technicians for each work task.

Work tasks are performed (block 104) on the assets as scheduled in the first schedule. For example, the work task may be thickness monitoring. Work task performances are measured for each of the work tasks (block 106) and task performance data corresponding to the measured task performance is generated. For thickness monitoring, the task performance data may be the accuracy of the measured thickness as compared to other measuring method, as discussed below.

Work task data from the work tasks performed is collected (block 108), and the work task data may include task performance data. Work task data is associated with each of the work tasks and the assets on which the work tasks were performed.

The work task performances that are measured may include a task performance time for each work task. Work task data collected is associated with the work tasks performed during the first project, including the task performance times. In some embodiments, a task performance time is measured from the time the work task is started at the location of the asset to the time that the work task is ended at the location of the asset being serviced. Other task data associated with the work tasks performed in the first project may be generated and/or collected, including identifying the technician or technicians performing each work task, tools used for each work task, supplies used for each work task, and completion time of each work task.

The work task performances that are measured may also include task performance accuracy. For example, most common methods of thickness monitoring in piping involve tangential X-ray or ultrasonic thickness tests. In one embodiment, an ultrasound monitoring system may be used, and while it has the advantage of being non-destructive, it requires the operation to be shut down in order to obtain more accurate readings. Therefore, the data collected by the ultrasound measurement can be collected and compared to other thickness monitoring results, such as the tangential radiography or probed UT. This would also factor into how much time it requires to complete the first work task, because if the thickness monitoring is less accurate, a supplemental measurement may be necessary.

The work task data from the first maintenance project may be used to help determine the condition of the assets inspected and/or repaired during the first maintenance project. For example, a corrosion rate of one of the assets may be determined based on an inspection of one of the assets during the first project.

A first predictive model is built (block 110) using work task data from the first project. The work task data from the first project includes current work task data from inspections and/or repairs performed during the first project. The first predictive model may be built using a combination of data, including current work task data, known task attribute data (block 112) and historical data (block 114).

The known task attribute data may include work task type, target asset, target asset characteristics, and at least one worker, such as a technician, assigned to perform a work task. For example, for wall thickness monitoring on the piping, block 112 would comprise attributes indicating the work task being thickness monitoring; the target asset being a pipe, a reactor, or a heat exchanger; the target asset characteristics being the type of reaction or fluid flowing through the asset and its flow rate; and the number of technician required to complete the task.

Historical data may include work task data from other maintenance projects on the assets, such as a previous project to maintain the assets inspected and repaired in the first project, or data obtained from other projects on similar assets. For example, historical data may include data on other assets, such as assets of the same type or a related type. The historical data may include data associated with different work task types, assets, plant system design, operating conditions, environmental conditions, and combinations of this data. For example, the historical data of the same fluid in different assets may be part of the historical data. Similarly, the historical data of one reaction type may be part of the historical data as applied to another reaction type, and the historical data of one temperature range may be part of the historical data as applied to other temperature range, etc. The historical data may be applied according to theoretical or empirical correlations or formulas.

The first predictive model may include a performance time component. The performance time component is used to predict the time for performance of each of the work tasks. The performance time component may be built using task performance time data and other data used to build the first predictive model.

Artificial intelligence (AI) may be used to process the work task data, known task data, and historical data to build the first predictive model. In some embodiments, building the first predictive model may include refining an earlier predictive model built using AI or other predictive model building methods. The first project may have a first project time duration extending from a first project start time T₁ₛₜₐᵣₜ to a first project end time T_{1end}. The first project time duration includes the time period to start and complete at least one work task on at least one asset. In some embodiments, the first project time duration will be the time from configuring the first schedule to starting and completing the work tasks in the first schedule on one or more assets.

It is also contemplated that other variables may also be calculated, such as the temperature, pressure, flow rate, fluid type or other conditions under which the work tasks are performed. For example, a first predictive model can also include a flow rate profile under which the first work task is performed in order to achieve better performance, as in some cases it may be beneficial to slow or entirely shut down the fluid flow inside the target asset.

The first predictive model provides a tool for configuring a subsequent, second schedule to be used in a second project to inspect and/or repair the assets of the first project. The second project occurs after the first project, as depicted by dashed line 10. The second schedule may provide adjustments of previous schedules for providing inspections and/or repairs to be performed on the assets after the first project. For example, the work tasks being performed, the type of inspections and/or repairs, the frequency of inspections and/or repairs, and the workforce assigned to perform the work tasks may be adjusted when using the first predictive model to configure the second schedule.

In the maintenance method 100, a second schedule is configured in a second project (block 120) to schedule work tasks and to assign a workforce to be performed in the second project. The second project of the maintenance method 100 is schematically illustrated in blocks 120-136 of FIG. 1. The second schedule includes the work tasks scheduled to be performed on the assets previously inspected and/or repaired in the first project under. In some embodiments, the second schedule may include work tasks to be performed on a subset of the assets that received inspection and/or repair during the first project.

The second schedule is configured (block 120) by applying the first predictive model (block 122) to configure the second schedule. More specifically, the second schedule may be configured by processing the known task attribute data (block 124) using the first predictive model. The known task attribute data for the second project may include work task type, target asset for maintenance, and a workforce available for performing inspections and/or repairs on the target assets. Configuring the second schedule includes identifying work tasks for performance on at least one of the assets. The identified work tasks of the second schedule may include inspections and/or repairs to provide maintenance to the assets.

In some embodiments, it is contemplated that the second schedule is configured based on the historical data and/or the work performance data obtained in blocks 106 and 108, such that a shorter or longer interval between two work tasks is scheduled. For example, if the work task data collected in 108 indicates that the maintenance is premature (no significant loss in wall thickness), it is therefore more economically beneficial to delay the time needed to perform the next inspection and repair. Or if the work task data collected 108 indicates that the maintenance is overdue (more severe loss in wall thickness), then it is necessary to move up the inspection schedule to prevent more damage to the asset.

The accuracy of the second schedule may be improved over the first schedule due to the use of the first predictive model in configuring the second schedule. The first predictive model uses the work task data from the first project to improve or refine the first predictive model. In addition, the accuracy of the predictive model increases each time the predictive model is updated by using additional historical data.

For example, the performance time component of the first predictive model may be used to configure the second schedule. The performance time component of the first predictive model may provide a model for use in predicting task performance times of work tasks to be performed in the second project. Because the task performance times may be more accurately modeled by using the performance time component of first predictive model, the second schedule may schedule the first work tasks with a higher degree of certainty. A more accurate second schedule allows for the more efficient allocation of resources for the inspections and/or repairs of the assets during the second project.

The second schedule is implemented like that described for implementation of the first schedule in the first project. Work tasks are performed (block 126) in the second project using the second schedule on the assets. Work task performances are measured (block 128) for each of the work tasks and task performance data corresponding to the measured task performance is generated. Work task data from the work tasks performed is collected (block 130), and the work task data may include task performance data. Work task data is associated with each of the work tasks and the assets on which the work tasks were performed.

A second predictive model is built (block 132) using work task data from the second project, known task attribute data (block 134), and historical data (block 136). The work task data collected in the second project includes work task data from current inspections and/or repairs performed during the second project. The known task attribute data may include work task type, target asset for maintenance, and a workforce available for performing maintenance. Historical data may include work task data from earlier projects, such as the first project, to inspect and/or repair the assets. In addition, historical data may include data on other assets, such as assets of the same type or a related type. The historical data may include data associated with different work task types, assets, plant system design, operating conditions, environmental conditions, and combinations of this data. In some embodiments, historical data is continuously updated during each of the successive projects, including the first project and the second project.

Artificial intelligence (AI) may be used to process the work task data and historical data to build the second predictive model. Different weight may be assigned to each factor involved based on theoretical or empirical analysis. Building the second predictive model may include refining the first predictive model. The second project may have a second project time duration extending from a second project start time T₂ₛₜₐᵣₜ to a second project end time T_{2end}. The second project time duration includes the time period to start and complete the work tasks of the second project on at least one asset. In some embodiments, the second project time duration will be the time from configuring the second schedule to starting and completing one or more work tasks in the second schedule on one or more assets.

Successive, additional projects after the second project may be performed (block 140) in a manner as described with respect to the first project and the second project. The additional projects may occur after the first project and the second project, as depicted by dashed line 12. For example, the second predictive model provides a tool for configuring a subsequent, third schedule to be used in a third project to inspect and/or repair the assets of the second project. Each successive project configures a new schedule using an updated predictive model as described with respect to the first project and the second project. In this manner, the set of work task data to build each successive predictive model may increase to improve each successive predictive model. The accuracy of each successive schedule likewise may improve.

In one embodiment, Inspection Work in block 104 is performed and material thickness is gathered (block 106) at the thickness measurement locations (TML), mechanical work and visual inspection of the asset provides further data on the asset's health (block 108). Corrosion rates are determined as a function of the data collected. Locations of corrosion are recorded.

Mechanical service data (known task attribute data collected through hot tapping services in block 112)/repair data (collected through previous leak repair services in block 114) is used in combination with corrosion rate information(visual and descriptive) and wall thickness data to build a model that correlates corrosion rates, locations on the asset with issues, wall thickness, failure data as a result of completed repairs to correlate remaining life and loss of primary containment as a function of data (block 110). The model will also help identify problem areas within assets that require more TMLs, more comprehensive inspection technology and/or more frequent inspection.

Recommendations to change inspection type, location/density of TMLs, and frequency are loaded into the 2nd project model. Work targets the trouble spots that have been guided by the 1st predictive model (block 120). Based on data collected as a result of the adjusted model (blocks 128, 130), the 2nd model is refined (block 132) to identify additional projects/insights that can extend the life of the asset (block 140).

The gained insight will drive work that focuses on common modes of failure for this asset type, geography or age. For example: corrosion under insulation solutions, corrosion under pipe support management as a result of failure modes observed and high corrosion rates around these locations of the asset can all be taken into consideration when refining the predictive models. The method can also include alarms that indicate the asset is near its end of life if multiple leak repairs have occurred on the asset.

The result is a customized service that understands how a particular asset ages and what solutions are best to inspect and repair the asset.

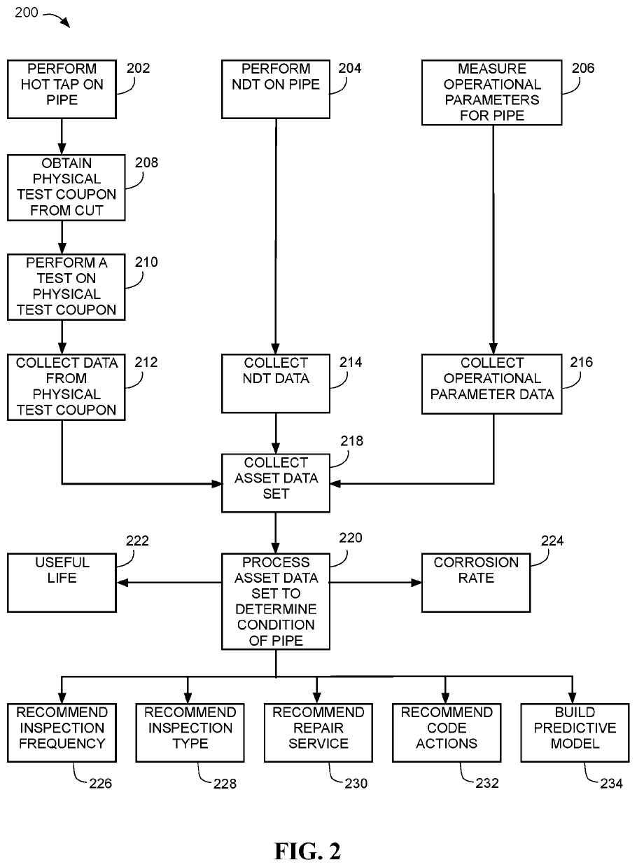

Another maintenance method for determining conditions of assets and recommending maintenance of the assets is shown in schematic form in FIG. 2, and generally designated as 200. Method 200 provides a method for collecting an asset data set to determine conditions of an asset and to make recommendations for maintenance of the asset. The asset data set is generated from data generated from work tasks performed on the asset and from data generated from sensors for the assets. The work tasks used to generate the asset data set may include non-destructive testing (“NDT”), destructive testing (“DT”), and repairs on the asset, such as a hot tap. Asset data may include operational parameters generated from sensors associated with the asset. The sensors may be temporarily coupled to the asset, or permanently mounted to the asset, depending on the asset type and the operational needs.

The asset data set generated and collected may be processed to determine the condition of the asset and to make maintenance recommendations, including inspection frequency, inspection type, repair services, and code actions. In addition, a predictive model may be built using the asset data set. The predictive model built may be used to determine conditions of the asset and to make maintenance recommendations based on successive asset data sets. For example, if the predictive model indicates the erosion/corrosion to the asset occurs at an accelerated rate, more frequent inspection and/or repairs may be configured. On the contrary, if the predictive model indicates that the erosion/corrosion to the asset occurs at a slower rate, less frequent inspection and/or repairs may be configured.

In an embodiment of the method 200, a hot tap is performed in block 202, a non-destructive testing (“NDT”) is performed in block 204, and operational parameters are measured for an asset, such as a pipe, in block 206. An example of method 200 is described for a pipe forming an asset. Embodiments of method 200 may also apply to other assets and systems including a fluid system having multiple assets.

The hot tap may be performed on a pressurized pipe as part of a work task to form a bypass joint at a tap location on the pipe. A wall of the pipe is cut during the hot tap to provide an access opening to the interior diameter (“ID”) of the pipe. The cut of the pipe removes a cut pipe section and a physical test coupon is obtained in block 208 from the cut pipe section.

In 210, testing may be performed on the physical test coupon to determine measurements, characteristics, and conditions of the pipe. The testing of the test coupon may include visual inspections for corrosion, measurements of a thickness of a wall, material inspections, positive material identifications (“PMIs”), carbon content, hardness, chemical composition, corrosion rate, and chemical attack, such as H2S corrosion damage. Data from the examination of the physical test coupon is collected from the testing in block 212.

The testing on the physical test coupon may be considered a form of destructive testing because the physical test coupon was obtained during a work task on the pipe to form a bypass joint at a selected location on the pipe where a section of the pipe was cut and removed. The data from testing the physical test coupon may be referred to as DT data.

The NDT on the pipe (block 204) may include electro-magnetic acoustic transducer (EMAT) screenings, ultrasound inspections, and manual inspections to determine a wall measurement or wall thickness of the pipe at a TML on the asset. NDT testing may be performed at multiple TMLs on the pipe. At least one of the TMLs may be proximate the hot tap location in some embodiments, such that the NDT testing results are comparable to the DT results. In some embodiments, at least one of the TMLs may be spaced axially on the pipe away from the hot tap location.

In block 214, NDT data is collected for the pipe from the performed NDT. The

NDT testing of the pipe may be performed to determine the corrosion rate of the pipe at one or more TMLs on the pipe.

EMAT is a transducer for non-contact acoustic wave generation and reception in conducting materials. Its effect is based on electromagnetic mechanisms, which do not need direct coupling with the surface of the material. EMAT works by generating ultrasonic waves into a test object using electromagnetic induction with two interacting magnetic fields. A relatively high frequency field generated by electrical coils interacts with a low frequency or static field generated by magnets to generate a Lorentz force in a manner similar to an electric motor. This disturbance is transferred to the lattice of the material, producing an elastic wave. In a reciprocal process, the interaction of elastic waves in the presence of a magnetic field induces currents in the receiving EMAT coil circuit. For ferromagnetic conductors, magnetostriction produces additional stresses that can enhance the signals to much higher levels than could be obtained by the Lorentz force alone.

Operational parameters measured for the pipe in block 206 may include pressure, temperature, vibration, and flow rate in the pipe. These parameters may be measured by automated sensors associated with the pipe, such as pressure sensors, temperature sensors, vibration sensors, bypass flow meters, and main-line flow meters, or other sensors known in the field. Sensors may be associated with the pipe or other assets coupled to the pipe. The sensors may be part of intelligent assets or equipment, such as valve gate sensors, sensors on a hot tap (HTS) machine communicating with a valve, and machines that cannot deploy unless a valve is open. In some embodiments, environmental data associated with the location of the pipe may be measured, including weather data such as temperature, pressure, and humidity of the soil and/or air in contact with the outer diameter (“OD”) of the pipe. In some embodiments, the environmental data may include the type of soil in contact with the OD of the pipe. Operational parameter data is collected (block 216) from the sensors associated with the pipe and from other data sources. In some embodiments, operational parameter data may include environmental data.

An asset data set is collected (block 218), and includes the DT data, NDT data, and operational parameter data. The asset data set is processed to determine a condition of the pipe (block 220). In some embodiments, multiple conditions of the pipe may be determined. For example, the asset data set may be processed to determine a useful life (block 222) of the pipe and to determine a corrosion rate (block 224) of the pipe. The asset data set may also be processed to determine a recommended inspection frequency (block 226), recommended inspection type (block 228), recommended repair service (block 230), recommended code actions (block 232) and to build a predictive model (block 234).

Generating and processing a combination of data, including data from the physical test coupon, NDT data on the pipe, and operational parameter data on the pipe, helps validate and refine maintenance recommendations and a condition of the pipe, such as corrosion rate.

The asset data collected may included data collected over multiple different projects performed to inspect and/or repair the asset at different times, such as during a scheduled maintenance project. As described with respect to method 100, successive predictive models may be built using the collected data from inspections and repairs at different times and projects to successively improve the predictive model. A predictive model may be used in processing the asset data set to determine the condition of the pipe (block 220), useful life (block 222) of the pipe, corrosion rate (block 224) of the pipe, and recommended actions (blocks 226-232) for the pipe.

In one embodiment, the recommended inspection frequency may be more frequent, the same as, or less frequent than the previous inspection frequency depending on the process asset data. For example, if the corrosion rate is higher than expected, a more frequent inspection frequency may be suggested in order to maintain the integrity of the asset.

In one embodiment, the recommended inspection type may be the same or different from the previous inspection type, depending on the results. For example, if a higher than expected corrosion rate is determined, a destructive inspection type may be recommended for future inspection, because the NDT may not always be accurate without actually being able to examine the ID of the pipe.

In some embodiments, the recommended repair service may depend on the type of fluid, the degree of corrosion identified during the testing, and the type of asset. For example, if the fluid is flammable in nature such as LPG gas, only cold repair is possible, where the operation needs to be shut down. More severe damage may require the whole section be replaced.

In some embodiments, the recommended code action involves API and AMSE engineering code requirements. In one embodiment, API 570 and ASME B31.3 codes are the code actions.

API 570—Piping Inspection Code is an inspection code developed and published by the American Petroleum Institute (API). The inspection code covers in-service inspection, rating repair, and alteration of metallic and fiberglass-reinforced plastic (FRP) piping systems and their respective pressure relieving devices. API 570 applies to piping systems that involve process fluids, hydrocarbons, chemical products, natural gas, high-pressure gasses, and other flammable or toxic fluids.

ASME B31.3 contains requirements for piping typically found in petroleum refineries; chemical, pharmaceutical, textile, paper, semiconductor, and cryogenic plants; and related processing plants and terminals. It covers materials and components, design, fabrication, assembly, erection, examination, inspection, and testing of piping. This Code applies to piping for all fluids including: (1) raw, intermediate, and finished chemicals; (2) petroleum products; (3) gas, steam, air and water; (4) fluidized solids; (5) refrigerants; and (6) cryogenic fluids.

Other code actions may also be used, for example, for inspections, API RP 574 for inspecting piping system components, API RP 577 for inspecting welding and metallurgy, API RP 571 for damage mechanism affecting fixed equipment in the refining industry, and API 578 for material verification program for new and existing ally piping systems. For repair, API STD 570 or ASME PCC-2 for repair of pressure equipment and piping.

In one embodiment, the data collected from the test coupon in step 212 may include minimum wall thickness, such as material data from test coupon: actual measured thickness, corrosion mode/defect type/shape, material strength. Also, the data collected in step 216 may include working pressure: Maximum allowable operation pressure(MAOP). Depending on the collected data, asset may need to be shut down, repaired, pressure or flow rates reduced in order to be code compliant.

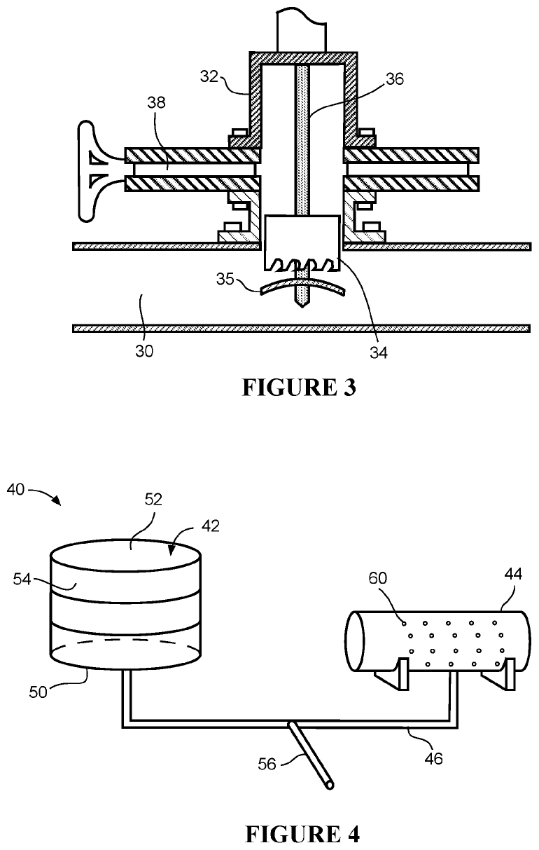

Referring to FIG. 3, an illustration of a hot tap being performed, referring also to block 202 in FIG. 2, on a pipe 30 is shown. In an embodiment of a hot tap, a fitting branch 32 is fitted at a location on a wall of the pipe 30. A cutter 34 in the fitting branch 32 is used to cut a lateral access opening in the pipe 30. Cutter 34 may be rotated by a shaft 36 to cut the pipe to remove a cut pipe section and form the lateral access opening in the pipe 30. The cut pipe section 35 may be obtained from the cutter 34 when the cutter 34 is removed from the fitting branch 32. A bypass line 38 may be attached to the fitting branch 32 to provide for fluid flow from the pipe 30 and through the bypass line 38. A physical test coupon may be taken from the cut pipe section 35 for testing to collect data to be used in determining the condition of the pipe 30.

Referring to FIG. 4, a fluid system 40 has multiple assets including a tank 42, a pressurized vessel 44, and a pipe 46 coupling the tank 42 and the pressurized vessel 44. Tank 42 includes a tank floor 50, a tank roof 52, and a side wall 54 formed by a first course, a second course, and a third course. Pipe 46 includes a pipe branch 56. Embodiments of the method 100 and method 200 of this disclosure may be applied to the fluid system 40. For example, NDT and DT may be performed at TMLs and condition monitoring locations (“CMLs”) of the assets of the fluid system 40. Standards, such as API 653, API 570, and API 510, may provide minimum inspection frequencies and other maintenance requirements or recommendations for the assets of the fluid system 40. Method 100 and/or method 200 may be used to determine conditions of the assets and/or fluid system 40 that would adjust the scheduling of maintenance. For example, an inspection frequency of at least one of the assets of the fluid system 40 may be initially scheduled for every ten years over a useful life of forty years. Use of the method 100 and/or method 200 may recommend an adjusted inspection frequency be scheduled for selected assets of the fluid system 40. For example, method 100 and/or method 200 may provide a recommendation to perform a selected number of TMLs on the vessel 44 at CML 60 at a different inspection interval, such as an inspection frequency of five years. By using the method 100 and/or method 200 on the fluid system 100, a more accurate condition of the assets may be determined, and more effective maintenance may be scheduled and performed.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded.

What is claimed is:

1. A method for maintaining a fluid containment asset, comprising:
configuring a first schedule having a first work task on the fluid containment asset for a first project;
performing the first work task on the fluid containment asset based on the first schedule;
measuring a work task performance for the first work task performed based on the first schedule;
collecting first work task data corresponding to the first work task performed;
building a first predictive model based on at least the first work task data;
configuring a second schedule using the first predictive model, wherein the second schedule has a second work task for a second project; and
performing the second work task on the fluid containment asset based on the second schedule.

2. The method of claim 1, further comprising:
collecting second work task data corresponding to the second work task performed; and
building a second predictive model based on the first work task data and the second work task data.

3. The method of claim 1, wherein the fluid containment asset is a pipe.

4. The method of claim 1, wherein the first predictive model is based on the first work task data, historical data, known task attribute data, or the combinations thereof

5. The method of claim 1, wherein the first work task is inspection, maintenance or repair of the fluid containment asset.

6. The method of claim 5, wherein the first work task is thickness monitoring.

7. The method of claim 1, wherein the first work task is hot tapping.

8. The method of claim 1, wherein the second work task is thickness monitoring.

9. A method for maintaining a fluid containment asset, comprising:
a) performing a destructive testing (DT) on the fluid containment asset to perform a DT test on a portion of the fluid containment asset;
b) performing a non-destructive testing (NDT) on the fluid containment asset to collect NDT data;
c) measuring operational parameters for the fluid containment asset to collect operational parameter data;
d) compiling an asset data set from the DT data, the NDT data and the operational parameter data;
e) processing the asset data set to determine condition of the fluid containment asset; and
f) performing at least one of the following:
i) determining a corrosion rate on the fluid containment asset,
ii) determining a useful life of the fluid containment asset,
iii) recommending an inspection frequency,
iv) recommending an inspection type;
v) recommending a repair service;
vi) recommending a code action; or
vii) building a predictive model.

10. The method of claim 9, wherein the fluid containment asset is a pipe.

11. The method of claim 9, wherein the destructive testing is a hot tap.

12. The method of claim 9, wherein the non-destructive testing is an ultrasonic testing, or an X-ray tangential testing.

13. The method of claim 9, wherein the operational parameters are selected from: a pressure in the fluid containment asset, a temperature in the fluid containment asset, vibration in the fluid containment asset, flow rate in the fluid containment asset, a temperature of the soil and/or air in contact with the outer diameter (“OD”) of the fluid containment asset, a pressure of the soil and/or air in contact with the OD of the fluid containment asset, a humidity of the soil and/or air in contact with the OD of the fluid containment asset, and the type of soil in contact with the OD of the fluid containment asset.
